(19) United States
(12) Patent Application Publication
(10) Pub. No.: US 2010/0047444 A1
(43) Pub. Date: Feb. 25, 2010

(54) ASSEMBLING NANOSTRUCTURES ON A SUBSTRATE

(76) Inventors: Seunghun Hong, Seoul (KR); Byeongju Kim, Incheon (KR)

Correspondence Address: Seunghun Hong, Asia Seonsuchon Apt. 6-205, Jamsil 7-dong, Songpa gu, Seoul, 138-797, KR

(21) Appl. No.: 12/197,724

(22) Filed: Aug. 25, 2008

(51) Int. Cl. B05D 1/12; B01J 19/08

(52) U.S. Cl. 427/180; 427/457

(57) ABSTRACT

Techniques for assembling nanostructures on a substrate are provided. Methods for assembling nanostructures on a substrate may involve, but are not limited to, detaching nanostructures from a wafer, passing the nanostructures through a filter, and assembling the nanostructures onto a patterned substrate.

### BACKGROUND

The present disclosure relates generally to the field of nanotechnology. Recently, nanotechnology has found widespread use in various fields. For example, nanotechnology is being used to build machines at a microscopic level and to construct nanoscale chips implanted in a human body. Accordingly, the ability to manipulate and place materials on a nanometer scale has become important for a number of uses.

A large number of new nanoscale devices are based on nanostructures having an intermediate size between molecular structures and microscopic (i.e., micrometer-sized) structures. Nanostructures can have various shapes, such as nanotubes, nanowires, nanoparticles, and the like or any combinations thereof, and confer superior properties to nanoscale devices, as compared with a conventional semiconductor device. For example, nanowires having diameters in the order of nanometers may be used to manufacture high speed flexible circuits and highly sensitive detectors. Also, nanotubes, which are cylinders made up of atomic particles and whose diameters are about one to a few billionths of a meter (e.g., carbon nanotubes), may be used to manufacture an interconnector that withstands a high current density. A nanotube has two dimensions in the nanoscale, whereas a nanoparticle, which has a spherical shape, has three dimensions in the nanoscale.

While there has been a large interest in new advanced devices based on nanostructures, a lack of large-scale integration techniques has been a major obstacle to the practical application of such devices. Since most nanostructures are prepared in a solution or powder form, it is necessary to use a process for aligning the nanostructures to specific positions on solid surfaces with a desired directionality in order to manufacture a device based on nanostructures.

A flow cell method and linker molecule method have been widely used to assemble and align nanostructures, such as conventional nanowires. In those methods, after the nanostructures are adsorbed onto specific positions on a solid surface, the nanostructures are directed to be aligned along the direction of a liquid flow.

A directed assembly process is also used for assembling nanostructures for the fabrication of nano-scale devices, such as electronic devices and sensors. In a directed assembly process, molecular patterns direct the assembly and alignment of nanostructures onto solid substrates without relying on any external forces. Such a process often requires a large quantity of nanomaterials that are normally synthesized on a wafer in only a small quantity. As a result, it is difficult to use the above directed assembly process for the fabrication of large scale devices using high purity but low quantity nanomaterials.

### SUMMARY

Various embodiments of methods for assembling nanostructures on a substrate are disclosed herein. Methods for assembling nanostructures on a substrate may involve one or more of the following: placing a first substrate having nanostructures on its surface in a first solvent under conditions effective to detach the nanostructures from the first substrate and disperse the nanostructures in a solution; passing the solution containing the nanostructures through a filter having a plurality of pores under conditions effective to retain and concentrate the nanostructures onto the filter; and providing the concentrated nanostructures to a second substrate, where the second substrate is patterned.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIGS. 1A-1D show schematic diagrams of illustrative embodiments of methods for assembling nanostructures on a substrate.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the components of the present disclosure may be arranged and designed in a wide variety of different configurations. Those of ordinary skill will appreciate that the functions performed in the methods may be implemented in differing order, and that the outlined steps are provided only as examples, and some of the steps may be optional, combined into fewer steps, or expanded to include additional steps without detracting from the essence of the present disclosure.

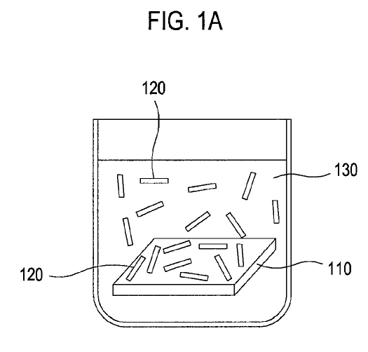

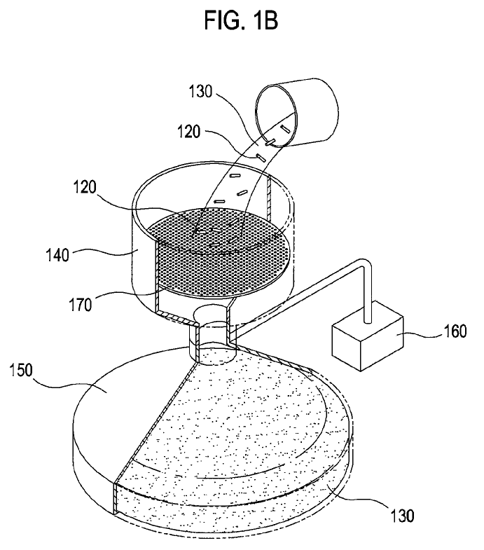

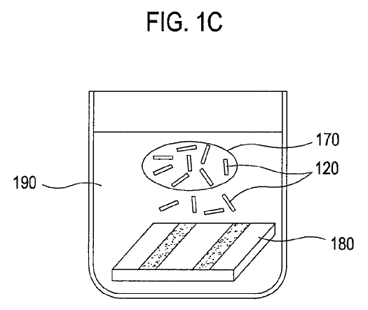

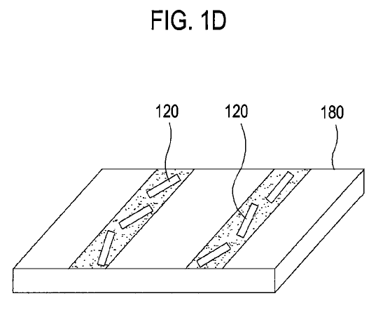

In one aspect, the disclosure provides for methods for assembling nanostructures on substrates. Referring to FIGS. 1A-1D, one embodiment of a method for assembling nanostructures on a substrate is illustrated. Initially, a first substrate having nanostructures on its surface is provided. Those of ordinary skill will appreciate that various methods may be used to synthesize nanostructures on the surface of a substrate by using various materials and apparatuses and that the outlined methods provided below are only examples and not meant to be limiting.

Thus, in accordance with one embodiment, nanostructures may be grown on a wafer, including a substrate and a silicon layer, in a growth chamber. The growth chamber may include a vacuum chamber, a gas supply, a vacuum pump, and a heater. The gas supply may supply a treatment gas to the vacuum chamber, while the vacuum pump may draw gas out of the vacuum chamber. The heater may then heat the silicon layer of the wafer to activate the synthesis of nanostructures (e.g., silicon nanowires or carbon nanotubes) via a vapor-liquid-solid (VLS) growth mechanism, which is a catalytic and site-specific growth process.

For silicon nanowire synthesis, a gold-palladium mixture may be sputtered onto the surface of the wafer to form a catalyst layer. Then, silane may be introduced to the vacuum chamber and the silicon layer may be heated to initiate the silicon nanowire synthesis process. In the above example, the VLS method uses silane as a source material. As the wafer becomes larger, more nanostructures may be synthesized on the wafer. The VLS reaction involves the interaction of silicon from the decomposition of silane with the catalyst's surface. Thus, the silicon diffuses into the catalyst, where the alloy becomes liquid phase when the silicon reaches the silicon-catalyst eutectic point. The liquid alloy continues to absorb silicon until it becomes supersaturated and the silicon begins to precipitate at the liquid-solid interface. The nanowires then form as a result of this axial precipitation process. In addition to the VLS method, other methods, such as, but not limited to, laser ablation and chemical beam epitaxy methods, may be used to synthesize nanowires.

In another embodiment, nanotubes may be synthesized by catalytic decomposition of a carbon-containing gas and then combining with nanometer-scale metal particles on a substrate. When hydrocarbon gases are provided as carbon feedstock molecules, they may decompose on the particle surface. Then, the resulting carbon atoms diffuse through the particle and precipitate as part of nanotubes growing from one side of the particle. Carbon nanotubes may also be generated by an arc evaporation of a graphite rod.

As illustrated in FIG. 1A, a first substrate 110, such as a wafer, having nanostructures 120 on its surface is placed in a first solvent 130 under conditions effective to detach the nanostructures from the first substrate and disperse the nanostructures in a solution. In one embodiment, the first solvent 130 containing the first substrate 110 may be sonicated using a sonication device for generating sound waves. The sonication device may include a power source, a control system, a temperature controlling system, and a sound wave generator for generating and transferring sound waves to the first solvent containing the first substrate.

Sonication applies sound energy, typically ultrasound energy, to agitate particles in a sample and, thus, is useful for facilitating dissolution by breaking intermolecular bonds. Since the nanostructures synthesized on a wafer are not well bonded to one another, bundles of the nanostructures can be broken down into individual nanostructures (e.g., nanotubes) and smaller bundles during sonication. Therefore, sonication can produce either a solution or a suspension of nanostructure materials, depending on the nature and quantity of the nanostructures and the liquid medium that is used.

For example, in order to detach nanostructures from a wafer, the wafer 110 is placed in a first solvent 130, such as water or an organic solvent, e.g., dichlorobenzene, dichloroethane, dimethylformamide (DMF), methylpyrrolidone (NMP), ethanol, and isopropanol. Then, the first solvent 130 containing the wafer 110 is sonicated, for example, at a high frequency of about 28 KHz or about 40 KHz for a predetermined time, for example, for about 5 minutes to about 1 hour so that the nanostructures 120 are detached from the wafer 110 and dispersed in a solution. In some embodiments, the sonication may be carried out at a frequency ranging from about 10 KHz to about 50 KHz, from about 20 KHz to about 50 KHz, from about 30 KHz to about 50 KHz, from about 40 KHz to about 50 KHz, from about 10 KHz to 20 KHz, from about 10 KHz to 30 KHz, from about 10 KHz to about 40 KHz, from about 20 KHz to about 30 KHz, or from about 30 KHz to about 40 KHz. In other embodiments, the sonication may be carried out at a frequency of about 10 KHz, about 20 KHz, about 30 KHz, about 40 KHz, or about 50 KHz. The sonication may be continued at a high frequency until the solution contains a saturated mixture of the nanostructures 120 and the first solvent 130. In some embodiments, the sonication may be carried out for about 10 minutes to about 1 hour, for about 20 minutes to about 1 hour, for about 30 minutes to about 1 hour, for about 40 minutes to about 1 hour, for about 50 minutes to about 1 hour, for about 5 minutes to about 10 minutes, for about 5 minutes to about 20 minutes, for about 5 minutes to about 30 minutes, for about 5 minutes to about 40 minutes, for about 5 minutes to about 50 minutes, for about 10 minutes to about 20 minutes, for about 20 minutes to about 30 minutes, for about 30 minutes to about 40 minutes, or for about 40 minutes to 50 minutes. In other embodiments, the sonication may be carried out for about 5 minutes, about 10 minutes, about 20 minutes, about 30 minutes, about 40 minutes, about 50 minutes, or about 1 hour. While carbon nanotubes are typically not damaged by sonication, nanowires occasionally break from sonication, so the optimal sonication may need to be determined by testing different sonication times depending on the length and diameter of the nanowires.

In another embodiment, the first solvent 130 for dispersing the nanostructures 120 from the wafer 110 may be deionized water for V₂O₅ nanowires and ZnO nanowires or may be ethanol for SnO₂ nanowires. Since different solvents may show different degrees of dispersion for the nanostructures, the solvent may be determined based on the nanostructures 120 to be detached from the wafer 110. Further, if the solvent itself sufficiently detaches and disperses the nanostructures 120 from the wafer 110, sonication need not be carried out to detach the nanostructures from the wafer. Alternatively, if the nanostructures 120 are not sufficiently detached by the first solvent 130 itself and/or by sonication, the nanostructures may be pretreated with substances that form a molecular coating by adding, for example, 3-aminopropyltriethoxysilane (APTES), to the first solvent in order to enhance the dispersion of the nanostructures.

As illustrated in FIG. 1B, the solution containing the nanostructures is passed through a filter having a plurality of pores. Any filtration method may be used, including but not limited to, e.g., gravity filtration and vacuum filtration. Vacuum filtration may be used to reduce the processing time compared to utilizing gravity flow.

In one embodiment, a vacuum-filtration apparatus, such as the one shown in FIG. 1B, may be used for filtering nanostructures from the solution. The vacuum-filtration apparatus may include a funnel 140, a flask 150, a vacuum pump 160, and a filter 170 placed on the funnel 140. The solution containing the nanostructures 120 is poured into the funnel 140 and passes through the filter 170. The vacuum pump 160 sucks air from the flask 150 to create a vacuum in the flask. The vacuum created by the vacuum pump 160 pulls the solution containing the nanostructures 120 through the funnel 140 into the flask 150, where the nanostructures 120 are retained and concentrated onto the filter 170 and a thin film of nanostructures 120 is formed on the filter 170. In some embodiments, the vacuum pump 160 is capable of decreasing the pressure within the flask 150 to, e.g., about 700 Torr to about 10⁻⁷ Torr. In other embodiments, the pressure may range from about 400 Torr to about 10⁻⁷ Torr, from about 100 Torr to about 10⁻⁷ Torr, from about 1 Torr to about 10⁻⁷ Torr, from about 10⁻³ Torr to about 10⁷ Torr, from about 700 Torr to about 400 Torr, from about 700 Torr to about 100 Torr, from about 700 Torr to about 1 Torr, from about 700 Torr to about 10⁻³ Torr, from about 400 Torr to about 100 Torr, or from about 100 Torr to about 1 Torr, or from about 1 Torr to about 10⁻³ Torr. In other embodiments, the pressure may be about 700 Torr, about 400 Torr, about 100 Torr, about 1 Torr, about 10⁻³ Torr, or about 10⁻⁷ Torr.

Table 1 below shows the approximate diameters and lengths of various illustrative nanostructures. Those of ordinary skill will appreciate that the numbers shown in the table are just illustrative and that the nanostructures may have larger or smaller diameters or lengths than the numbers given below, depending on how the nanostructures are synthesized.

TABLE 1
Illustrated Nanostructures

| Type of Nanostructure | Diameter | Length |
|---|---|---|
| Single-walled carbon nanotube | 1~2 nm | ~1 micron |
| Multi-walled carbon nanotube | 5~10 nm | ~ a few hundred nm |
| V₂O₅ nanowire | 1~5 nm | 1~2 microns |
| In₂O₃ nanowire | 5~10 nm | a few ~ a few tens |
| | | of microns |
| Liquid Phase grown ZnO nanowire | ~400 nm | 3~5 microns |
| CVD grown ZnO nanowire | 5~10 nm | ~ a few microns |
| SnO₂ nanowire | 5~10 nm | ~1 mm |

In another embodiment, the filter 170 may have a plurality of pores, the size of which is smaller than the size of the nanostructures to be filtered. For example, when multi-walled carbon nanotubes having diameters of 10 nm are to be filtered, the filter may have pores smaller than 10 nm, so that the nanostructures cannot pass through the pores of the filter, resulting in a thin film of nanostructures on the filter. While more nanostructures may be able to be retained by the filter as the size of the pores becomes smaller, in actuality, the filter may have pores larger than the diameter of the nanostructures because, in most cases, the nanostructures typically approach the filter with a certain angle rather than approach it vertically since the nanostructures are randomly dispersed in the solution. Thus, for example, when single-walled carbon nanotubes are filtered, the pore size of the filter may be 20 nm.

As mentioned above, if the nanostructures 120 are not sufficiently detached by the first solvent 130 itself and/or by sonication, substances that form a molecular coating on the nanostructures may be added to help the dispersion. Since these substances sometimes change the characteristics of the nanostructures, they may need to be subsequently removed from the nanostructures. In one embodiment, a substance capable of removing the molecular coating from the nanostructures is added to the solution containing the nanostructures, while the solution containing the nanostructures is passed through the filter. Thus, the pore size of the filter may be determined based not only on the size of the nanostructures but also on other factors, such as but not limited to, the size of the organic impurities, such as the removed molecular coating, introduced in the solution. Therefore, in another embodiment, the filter may have a plurality of pores, the sizes of which may be smaller than the size of the nanostructures but larger than that of organic impurities, e.g., the removed molecular coating, so that the impurities can be removed by the filtering process. Impurities may also have been introduced into the solution, for example, while the nanostructures were synthesized/grown on wafers and/or dispersed in the solution. Typically, the size of the organic impurities is a few nanometers. On the other hand, if the pore size is too large, e.g., larger than the length of the nanostructures, not only would most of the impurities pass through the filter, but also would most of the nanostructures, whereby only a small amount of nanostructures would be retained by the filter.

A variety of different types of filters may be used for the method illustrated above, such as but not limited to, cellulose filters, polytetrafluoroethylene filters, and glass microfiber filters. The filter 170 may also have a variety of sizes. In one embodiment, the filter 170 may be a circular shape having a diameter ranging from about 1 mm to about 100 mm. In some embodiments, the diameter of the filter 170 may range from about 25 mm to about 100 mm, from about 50 mm to about 100 mm, from about 75 mm to about 100 mm, from about 1 mm to about 25 mm, from about 1 mm to about 50 mm, from about 1 mm to about 75 mm, from about 25 mm to 50 mm, or from about 50 mm to 75 mm. In other embodiments, the diameter of the filter 170 may be about 1 mm, about 25 mm, about 50 mm, about 75 mm, or about 100 mm. Using a smaller size filter may facilitate the concentration of a higher number of nanostructures on the filter. If the area of the filter to which the solution is poured is smaller than the filter or if the size of the wafer is larger (i.e., higher number of nanostructures), the higher density, one may obtain a filter having a high density of nanostructures, which can in turn be deposited onto a solid substrate.

In some embodiments, the filter 170 having the concentrated nanostructures 120 may be placed on top of a second substrate 180 that is patterned. In other embodiments, the filter having the concentrated nanostructures and the second substrate that is patterned may be placed in a second solvent 190 under conditions effective to detach the nanostructures from the filter, as illustrated in FIG. 1C. Various methods similar to those for detaching the nanostructures from the wafer may be used to detach the nanostructures from the filter. For example, the solvent containing the filter and the second substrate can be sonicated in order to aid the detachment of the nanostructures from the filter. In addition, the second substrate 180 may be kept in the solution vessel for a predetermined time, for example, from 1 minute to about 3 days, while subjecting the solution to sonication. In some embodiments, the second substrate 180 may be kept in the solution vessel for about 1 hour to about 3 days, for about 5 hours to about 3 days, for about 10 hours to about 3 days, for about 1 day to about 3 days, for about 2 days to about 3 days, for about 1 minute to about 1 hour, for about 1 minute to about 5 hours, for about 1 minute to about 10 hours, for about 1 minute to 1 day, for about 1 minute to about 2 days, for about 1 hour to about 5 hours, for about 5 hours to about 10 hours, for about 10 hours to about 1 day, or for about 1 day to about 2 days. In other embodiments, it may be kept in the solution vessel for about 1 minute, about 1 hour, about 5 hours, about 10 hours, about 1 day, about 2 days, or about 3 days.

The detached nanostructures 120 from the filter are then transferred to the second substrate 180 that is patterned, where they are allowed to assemble and align according to the molecular pattern on the second substrate, as illustrated in FIG. 1D. While no additional forces are required to align the nanostructures on the second substrate because the molecular patterns on the second substrate align the nanostructures into specific directions, in some embodiments, the temperature of the nanostructure solution may be raised, e.g., up to about 30° C., about 40° C., or about 50° C., in order to enhance the adsorption of the nanostructures on the molecular layer.

The substrate may also be vibrated at a frequency of 28 KHz or 40 KHz for about 5 minutes to about 1 hour to enhance the adsorption of the nanostructures on the molecular layer. In some embodiments, the vibration may be carried out at a frequency ranging from about 10 KHz to about 50 KHz, from about 20 KHz to about 50 KHz, from about 30 KHz to about 50 KHz, from about 40 KHz to about 50 KHz, from about 10 KHz to 20 KHz, from about 10 KHz to 30 KHz, from about 10 KHz to 40 KHz, from about 20 KHz to 30 KHz, or from about 30 KHz to about 40 KHz. In other embodiments, the frequency may be about 10 KHz, about 20 KHz, about 30 KHz, about 40 KHz, or about 50 KHz. Further, in some embodiments, the vibration may be carried out for about 10 minutes to about 1 hour, for about 20 minutes to about 1 hour, for about 30 minutes to about 1 hour, for about 40 minutes to about 1 hour, for about 50 minutes to about 1 hour, for about 5 minutes to about 10 minutes, for about 5 minutes to about 20 minutes, for about 5 minutes to about 30 minutes, for about 5 minutes to about 40 minutes, for about 5 minutes to about 50 minutes, for about 10 minutes to about 20 minutes, for about 20 minutes to about 30 minutes, for about 30 minutes to about 40 minutes, or for about 40 minutes to 50 minutes. In other embodiments, the vibration may be carried out for about 5 minutes, about 10 minutes, about 20 minutes, about 30 minutes, about 40 minutes, about 50 minutes, or about 1 hour.

Further, the amount of the nanostructures to be adsorbed onto the substrate may be changed by applying an electric potential to the substrate. Different electric potentials may be applied to the substrate, depending on the surface charge of the nanostructures being adsorbed onto the substrate. For example, if the surface charge of the nanostructures is negative, a voltage of about +5 V may be applied to the substrate, whereas if the surface charge of the nanostructures is positive, a voltage of about −5 V may be applied to the substrate in order to increase the amount of the nanostructures being adsorbed on the substrate. In some embodiments, the absolute value of the voltage applied to the substrate may range from about 1 V to about 5 V, from about 2 V to about 5 V, from about 3 V to about 5 V, from about 4 V to about 5 V, from about 1 V to about 2 V, from about 1 V to about 3 V, from about 1 V to about 4 V, from about 2 V to about 3 V, or from about 3 V to about 4 V. In other embodiments, the absolute value of the voltage applied to the substrate may be about 1 V, about 2 V, about 3 V, about 4 V, or about 5 V.

In another embodiment, when the nanostructures to be adsorbed are carbon nanotubes, the molecular layer may be hydrophobic molecular layers. For example, 1-octadecanethiol (ODT) molecules may be used to form hydrophobic molecular layers on Au and Ag substrates.

In one embodiment, the second substrate may be patterned, for example, by using dip-pen nanolithography, micro-contact printing, photolithography, e-beam lithography, nano-grafting, nano-shaving, scanning tunneling microscope (STM) lithography, or the like.

For example, in one embodiment using a photolithography method, a photoresist pattern may be formed on a substrate by photolithography. When the photoresist patterned substrate is placed in a molecular solution, the molecules in the solution may be adsorbed selectively onto the surface regions of the substrate where the photoresist layer does not exist. The patterned substrate may be rinsed with an anhydrous material, such as but not limited to, anhydrous hexane, in order to remove the residual surface water on the substrate. For example, octadecyltrichlorosilane may be used as molecular layers in patterning carbon nanotubes or V₂O₅ nanowires on oxide surfaces such as SiO₂ glass. Then, the molecular layers can be obtained by dissolving and removing the photoresist by a solvent, such as but not limited to, acetone.

In another embodiment using a micro-contact printing method, a 1-octadecanethiol (ODT) molecular layer may be patterned by micro-contact printing. In this embodiment, a stamp coated with an ODT solution is in contact with an Au/Ti layer deposited on a Si wafer. The stamp is dried and pressed onto the surface of a substrate to be patterned. Then, the stamp makes contact with the surface and the molecules are transferred from the stamp to the substrate.

In one embodiment, after the nanostructures are detached from the filter and sufficiently dispersed in the second solvent, the filter may be removed from the solution vessel. Further, when a sufficient amount of nanostructures are assembled and aligned onto the patterned substrate, the substrate may be removed from the solution and rinsed and dried, thereby resulting in a substrate having nanostructures aligned on the molecular patterns. For example, the substrate may be rinsed with deionized water and/or may be dried in an inert gas flux.

The above description provides a method for concentrating various high purity nanostructures from wafers onto a filter and transferring and aligning those nanostructures onto a substrate. The method described in the present disclosure allows one to fabricate nanodevices having a high density of precisely assembled/aligned nanostructures, without being limited by the small quantity of nanostructures adsorbed to the wafer that is being used.

### Equivalents

The present disclosure is not to be limited in terms of the particular embodiments described in this application. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, or compositions, which can, of course, vary. It is also to be understood that the terminology used herein is for the purpose of describing particular embodiments only, and is not intended to be limiting.

For this and other processes and methods disclosed herein, one skilled in the art can appreciate that the functions performed in the processes and methods may be implemented in different orders, sequentially, concurrently, and/or repetitively. Further, the outlined steps and operations are only provided as examples. That is, some of the steps and operations may be optional, combined into fewer steps and operations, or expanded into additional steps and operations without detracting from the essence of the disclosed embodiments.

In light of the present disclosure, those skilled in the art will appreciate that the apparatus and methods described herein may be implemented in hardware, software, firmware, middleware or combinations thereof and utilized in systems, subsystems, components or sub-components thereof. For example, a method implemented in software may include computer code to perform the operations of the method. This computer code may be stored in a machine-readable medium, such as a processor-readable medium or a computer program product, or transmitted as a computer data signal embodied in a carrier wave, or a signal modulated by a carrier, over a transmission medium or communication link. The machine-readable medium or processor-readable medium may include any medium capable of storing or transferring information in a form readable and executable by a machine (e.g., by a processor, a computer, etc.).

The present disclosure may be embodied in other specific forms without departing from its basic features or characteristics. Thus, the described embodiments are to be considered in all respects only as illustrative and not restrictive. The scope of the disclosure is, therefore, indicated by the appended claims, rather than by the foregoing description. All changes within the meaning and range of equivalency of the claims are to be embraced within their scope.

What is claimed is:

1. A method for assembling nanostructures on a substrate, said method comprising:
placing a first substrate having nanostructures on its surface in a first solvent under conditions effective to detach the nanostructures from the first substrate and disperse the nanostructures in a solution;
passing said solution containing the nanostructures through a filter having a plurality of pores under conditions effective to retain and concentrate the nanostructures onto said filter; and
providing the concentrated nanostructures to a second substrate, wherein the second substrate is patterned.

2. The method of claim 1, wherein said placing the first substrate in a first solvent comprises sonicating the first solvent containing said first substrate.

3. The method of claim 1, wherein said placing the first substrate in a first solvent comprises placing said first substrate in water or an organic solvent.

4. The method of claim 1, wherein said passing said solution containing the nanostructures through a filter is carried out by vacuum filtration.

5. The method of claim 1, wherein the size of the pores of said filter is smaller than the size of the nanostructures.

6. The method of claim 1, further comprising pretreating the nanostructures with a molecular coating, prior to said placing said first substrate in a first solvent, under conditions effective to facilitate the dispersion of the nanostructures in the first solvent.

7. The method of claim 6, further comprising while passing said solution containing the nanostructures through a filter, adding to said solution a substance capable of removing the molecular coating from the nanostructures.

8. The method of claim 7, wherein the size of the pores of the filter is smaller than the size of the nanostructures and larger than the size of the removed molecular coating.

9. The method of claim 1, wherein said providing the concentrated nanostructures to a second substrate comprises placing said filter having the concentrated nanostructures on top of a second substrate that is patterned.

10. The method of claim 1, wherein said providing the concentrated nanostructures to a second substrate comprises placing the filter having the concentrated nanostructures and a second substrate that is patterned in a second solvent under conditions effective to detach the nanostructures from the filter and allow the assembly of the nanostructures onto the second substrate.

11. The method of claim 10, wherein said placing the filter having the concentrated nanostructures and the second substrate that is patterned in a second solvent comprises sonicating the second solvent containing the filter and the second substrate.

12. The method of claim 10, further comprising removing the filter and rinsing the patterned second substrate onto which the nanostructures are assembled with a third solvent, after said placing the filter having the concentrated nanostructures and the second substrate that is patterned in a second solvent.

13. The method of claim 10, wherein said placing the filter having the concentrated nanostructures and the second substrate that is patterned in a second solvent further comprises applying an electric potential to the second substrate.
